(19) United States
(12) Patent Application Publication
(10) Pub. No.: US 2024/0104410 A1
(43) Pub. Date: Mar. 28, 2024

(54) METHOD AND DEVICE WITH CASCADED ITERATIVE PROCESSING OF DATA

(71) Applicant: SAMSUNG ELECTRONICS CO., LTD., Suwon-si (KR)

(72) Inventors: Jiaqian Yu, Beijing (CN); Yiwei CHEN, Beijing (CN); Yifan YANG, Beijing (CN); Byung In YOO, Suwon-si (KR); Changbeom PARK, Suwon-si (KR); Dongwook LEE, Suwon-si (KR); Qiang WANG, Beijing (CN); Siyang PAN, Beijing (CN)

(73) Assignee: SAMSUNG ELECTRONICS CO., LTD., Suwon-si (KR)

(21) Appl. No.: 18/466,139

(22) Filed: Sep. 13, 2023

(30) Foreign Application Priority Data
Sep. 27, 2022 (CN) 202211186550.8
May 23, 2023 (KR) 10-2023-0066511

(51) Int. Cl. G06N 5/046; G06N 20/20

(52) U.S. Cl. CPC G06N 5/046; G06N 20/20; G06V 10/82

(57) ABSTRACT

Disclosed is a method and device for processing data, and the method includes generating a target augmentation task sequence by processing the target data with a trained first model that performs inference on the target data to generate the target data augmentation task sequence, generate augmented target data by performing data augmentation on the target data according to the target augmentation task sequence, and obtaining a prediction result corresponding to the target data by inputting the augmented target data to a trained second model and performing a corresponding processing on the augmented target data by the trained second model.

### CROSS-REFERENCE TO RELATED APPLICATIONS

This application claims the benefit under 35 USC § 119(a) of Chinese Patent Application No. 202211186550.8 filed on Sep. 27, 2022, in the China National Intellectual Property Administration, and Korean Patent Application No. 10-2023-0066511 filed on May 23, 2023, in the Korean Intellectual Property Office, the entire disclosures of which are incorporated herein by reference for all purposes.

### BACKGROUND

### 1. Field

The following description relates to the field of an artificial intelligence technology, and more particularly, to a data processing method, an electronic device, a storage medium, and a program product.

### 2. Description of Related Art

Data augmentation is a common technology used in the field of machine learning to improve robustness of neural networks The implementation of such a technology may allow an additional sample to be generated from existing data without increasing the amount of existing data.

With test time data augmentation (TTA), a single augmentation is performed for each piece (item) of test data. However, as observed only by the inventors, the single augmentation approach may not be adequate for severely corrupted test data, which can make it difficult to obtain a good prediction result when a model predicts an augmented sample.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of processing data includes obtaining target data, generating a target augmentation task sequence by processing the target data with a trained first model that performs inference on the target data to generate the target data augmentation task sequence, generate augmented target data by performing data augmentation on the target data according to the target augmentation task sequence, and obtaining a prediction result corresponding to the target data by inputting the augmented target data to a trained second model and performing a corresponding processing on the augmented target data by the trained second model.

The target augmentation task sequence may include at least two augmentation tasks selected by cascaded test time augmentation (TTA) performed by the first model.

The trained first model may include a first network configured to determine a state feature by performing a first processing of the target data, a second network configured to determine a target augmentation task corresponding to a current iteration of the trained first model based on a state feature of the current iteration determined by the first network processing the target data, and a third network configured to determine a state feature of a next iteration based on the state feature of the current iteration and the target augmentation task corresponding to the current iteration.

The generating of the target augmentation task sequence by processing the target data based on the trained first model may include, in response to the target augmentation task corresponding to the current iteration being an augmentation task other than an identity task, determining, by the third network, the state feature of the next iteration based on the state feature of the current iteration and the target augmentation task corresponding to the current iteration, and determining, by the second network, a target augmentation task of the next iteration based on the state feature of the next iteration until an iteration termination condition is satisfied through the second network, and in response to the termination condition being satisfied the target augmentation task sequence.

The iteration termination condition may include at least one of a case where a target augmentation task corresponding any iteration is the identity task, or a case where a number of iterations reaches a preset maximum number of iterations.

The determining of the target augmentation task of the next iteration based on the state feature of the next iteration through the second network may include determining, by the second network, an output vector of the next iteration based on the state feature of the next iteration, and determining, as a target augmentation task of the next iteration, an augmentation task corresponding to a vector satisfying a preset condition in the output vector of the next iteration.

The generating of the target augmentation task sequence by processing the target data based on the trained first model may include, in response to a number of the target augmentation tasks determined in the current iteration being N, wherein N is an integer greater than 1, determining the state feature of the next iteration for each target augmentation task and the state feature of the current iteration, determining one target augmentation task of the next iteration based on the state feature of the next iteration, and outputting N target augmentation task sequences by sequentially performing the iteration until the preset iteration termination condition is satisfied, determining the state feature of the next iteration for each target augmentation task and the state feature of the current iteration, determining N target augmentation tasks of the next iteration based on the state feature of the next iteration, determining, as a target augmentation task of the next iteration, N augmentation tasks from determined N*N augmentation tasks, and outputting N target augmentation task sequences by sequentially performing the iteration until the preset iteration termination condition is satisfied, or determining the state feature of the next iteration for each target augmentation task and the state feature of the current iteration, and outputting a plurality of target augmentation task sequences by determining N target augmentation tasks of the next iteration until the preset iteration termination condition is satisfied based on the state feature of the next iteration.

The current iteration may include a first iteration.

The obtaining of the prediction result corresponding to the target data by inputting the augmented target data to the trained second model and performing the corresponding processing on the augmented target data may include, in response to the target augmentation task sequence including a plurality of augmentation tasks, obtaining a plurality of output results by inputting, to the trained second model, each of a plurality of pieces of augmented target data obtained by augmenting data based on the target augmentation task sequence, and obtaining the prediction result corresponding to the target data by integrating the plurality of output results.

A process of training a first model that becomes the trained first model may include determining, based on obtained training data, first rank losses of respective predefined augmentation tasks of next iteration training through the first network and the second network, and optimizing the first model based on the first rank losses, and determining, based on training data of current iteration training, second rank losses of the respective predefined augmentation tasks of the next iteration training through the second network and the third network, and optimizing the first model based on the second rank losses until a number of iterations reaches a preset maximum number of iterations.

The determining of, based on the training data of the current iteration training, the second rank losses, and optimizing the first model based on the corresponding rank loss until the number of iterations reaches the preset maximum number of iterations may include determining one augmentation task among the predefined augmentation tasks as a training augmentation task of the next iteration training, obtaining training data of the next iteration training by performing the training augmentation task of the next iteration training on the training data of the current iteration training, and determining the rank losses of the next iteration training through the second network and the third network based on the training data of the next iteration training.

The determining of the rank loss of each preset augmentation task of the next iteration training through the first network and the second network, and the determining of the rank loss of each preset augmentation task of the next iteration training through the second network and the third network may include performing each predefined augmentation task on training data of the next iteration training, obtaining a loss value by inputting, to the second model, training data obtained by the performing the predefined augmentation tasks, and determining a training label of the next iteration training based on the loss value and determining a rank loss of each augmentation task obtained from the next iteration training based on the corresponding training label.

The determining of the rank loss of each augmentation task obtained from the next iteration training based on the corresponding training label may include obtaining an output vector output from the second network for the next iteration training, and determining the rank loss of each augmentation task of the next iteration training by matching the output vector of the next iteration training to the corresponding training label.

In another general aspect, a data processing device includes a processor. The processor is configured to obtain target data, generate a target augmentation task sequence by processing the target data with a trained first model, perform data augmentation on the target data according to the target augmentation task sequence to generate augmented target data, and obtain a prediction result corresponding to the target data by inputting the augmented target data to a trained second model that performs a corresponding processing on the augmented target data.

The trained first model may include a first network configured to determine a state feature of a first processing of the target data, a second network configured to determine a target augmentation task corresponding to a current iteration based on a state feature of the current iteration, and a third network configured to determine a state feature of a next iteration based on the state feature of the current iteration and the target augmentation task corresponding to the current iteration.

The processor may be configured to, in a case of generating the target augmentation task sequence by processing the target data based on the trained first model, in response to the target augmentation task corresponding to the current iteration being an augmentation task other than an identity task, determining the state feature of the next iteration based on the state feature of the current iteration and the target augmentation task corresponding to the current iteration through the third network, and outputting the target augmentation task sequence by determining a target augmentation task of the next iteration based on the state feature of the next iteration until a preset iteration termination condition is satisfied through the second network.

The iteration termination condition may include at least one of a case where a target augmentation task corresponding to all iterations is the identity task, or a case where a number of iterations reaches a preset maximum number of iterations.

The processor may be configured to determine an output vector of the next iteration based on the state feature of the next iteration through the second network, and determining, as a target augmentation task of the next iteration, an augmentation task corresponding to a vector satisfying a preset condition in the output vector of the next iteration.

The processor may be configured to, in a case of obtaining the at least one target augmentation task sequence by processing the target data based on the trained first model, in response to a number of the target augmentation tasks determined in the current iteration being N, wherein N is an integer greater than 1, determine the state feature of the next iteration for each target augmentation task and the state feature of the current iteration, determine one target augmentation task of the next iteration based on the state feature of the next iteration, and output N target augmentation task sequences by sequentially performing the iteration until the preset iteration termination condition is satisfied, determine the state feature of the next iteration for each target augmentation task and the state feature of the current iteration, determine N target augmentation tasks of the next iteration based on the state feature of the next iteration, determine, as a target augmentation task of the next iteration, N augmentation tasks from determined N*N augmentation tasks, and output N target augmentation task sequences by sequentially performing the iteration until the preset iteration termination condition is satisfied, or determine the state feature of the next iteration for each target augmentation task and the state feature of the current iteration, and output a plurality of target augmentation task sequences by determining N target augmentation tasks of the next iteration until the preset iteration termination condition is satisfied based on the state feature of the next iteration.

The present disclosure provides a data processing method and device. Specifically, when obtaining target data for a test in a test operation, first, at least one target augmentation task sequence including at least two augmentation tasks cascaded by processing target data based on a pre-trained first model is obtained. Then, data may be augmented for the target data based on the corresponding target augmentation task sequence, and a prediction result corresponding to the target data may be obtained by inputting the augmented target data to a trained second model and processing the augmented target data accordingly. In the implementation of the technical solution of the present disclosure, a series of target augmentation tasks corresponding to the target data may be adaptively predicted in a stepwise manner through the cascade iteration processing method of the target data under the premise of not changing the second model, and a more suitable augmentation task may be found by expanding a search space and an upper bound of the augmentation task with lower computational cost. Also, by testing the trained second model based on the augmented target data, a better prediction effect than the existing method may be obtained.

Other features and aspects will be apparent from the following detailed description, the drawings, and the claims.

### BRIEF DESCRIPTION OF THE DRAWINGS

FIG. 1 illustrates an example of processing data, according to one or more embodiments.

FIG. 2 illustrates example augmentation tasks, according to one or more embodiments.

FIG. 3 illustrates an example of testing, according to one or more embodiments.

FIG. 4 illustrates an example of processing by a first model, according to one or more embodiments.

FIG. 5 illustrates an example of an expanded search space, according to one or more embodiments.

FIG. 6A illustrates another example of testing, according to one or more embodiments.

FIG. 6B illustrates another example of testing, according to one or more embodiments.

FIG. 6C illustrates another example of testing, according to one or more embodiments.

FIG. 7 illustrates an example configuration of a label builder, according to one or more embodiments.

FIG. 8A illustrates an example of training a first model, according to one or more embodiments.

FIG. 8B illustrates another example of training a first model, according to one or more embodiments.

FIG. 8C illustrates another example of training a first model, according to one or more embodiments.

FIG. 8D illustrates another example of training a first model in a data processing device, according to one or more embodiments.

FIG. 9 illustrates an example of training a first model, according to one or more embodiments.

FIG. 10 illustrates an example of determining a rank loss of each predetermined augmentation task of a next iteration through second and third networks, according to one or more embodiments.

FIG. 11 illustrates an example of determining a rank loss of predetermined augmentation tasks of a next iteration, according to one or more embodiments.

FIG. 12 illustrates an example of determining rank losses of respective augmentation tasks obtained for a next training iteration based on a corresponding training label, according to one or more embodiments.

FIG. 13 illustrates an example of training a first model, according to one or more embodiments.

FIG. 14 illustrates an example of obtaining a target augmentation operation sequence, according to one or more embodiments.

FIG. 15 illustrates an example of determining a target augmentation task of a next iteration based on a state feature of the next iteration through a second network, according to one or more embodiments.

FIG. 16 illustrates an example of testing a first model, according to one or more embodiments.

FIG. 17 illustrates an example of a visualization effect of a classification task for a setting data set, according to one or more embodiments.

FIG. 18 illustrates an example of an effect of a target detection task, according to one or more embodiments.

FIG. 19 illustrates an example configuration of a data processing device, according to one or more embodiments.

FIG. 20 illustrates an electronic device, according to one or more embodiments.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Some objects of some techniques described herein are to adapt an augmentation demand during a test operation, expand a search space and an upper bound for an augmentation task, and increase a prediction effect by finding a more suitable augmentation task.

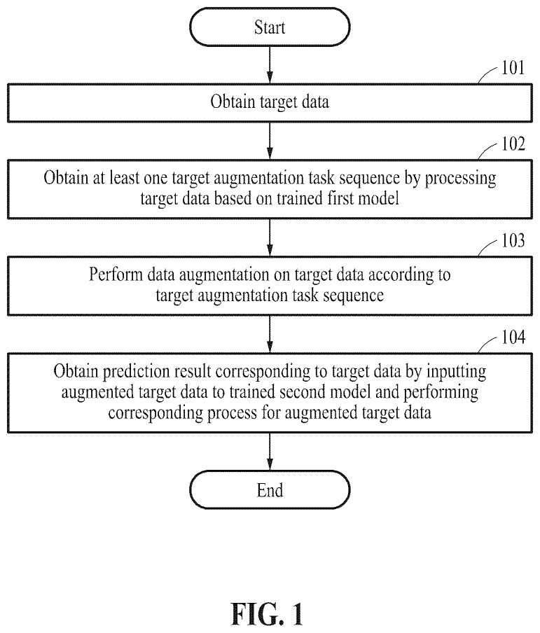

FIG. 1 illustrates an example of processing data, according to one or more embodiments.

Referring to FIG. 1, a data processing device may be any electronic device such as a terminal or a server. The terminal may be a smartphone, tablet, notebook, desktop computer, smart speaker, smart watch, vehicle-mounted device, or the like. The server may be an independent physical server, or a server cluster or distributed system including multiple physical servers, or may be a cloud server that may provide a basic cloud computing service such as a cloud service, a cloud database, cloud computing, a cloud function, cloud storage, a network service, a cloud communication, a middleware service, a domain name service, a security service, a content delivery network (CDN), big data, and an AI platform, but is not limited thereto.

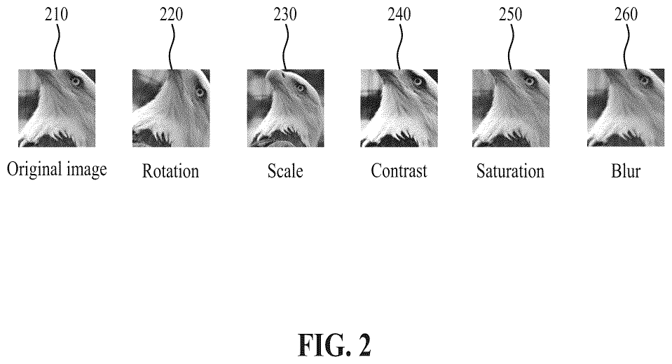

Specifically, FIG. 1 shows operations 101 to 104 that may be used for testing a model. The operations of FIG. 1 relate to a trained first model and a trained second model. Each model may include one or more neural networks. As described with reference to FIGS. 1 and 2, the first model may obtain a target augmentation task sequence (e.g., image transform operations) and the second model may perform inference on augmented data (e.g., images transformed by the image transform operations found by the first model).

First, in operation 101, the data processing device may obtain target data. The target data may belong to test data of a test set of the second model. The test set may include pieces of test data, each of which may, in turn, serve as the target data mentioned in operation 101. That is, the following operations 102 to 104 may be implemented for each test data.

The target data may be suitable for various application scenarios and may be of various types of data. For example, the target data may be image data in an image processing scenario and may be audio data (e.g., voice data) in an audio processing scenario. To describe various examples, the target data will be described hereafter as image data (e.g., a test image). However, this is just one example of the type of data the target data may be.

In operation 102, the data processing device may obtain the target augmentation task sequence, which may be augmentation tasks that are cascaded by processing target data based on the trained first model. Cascading is described later.

The trained first model and the trained second model may be neural network models independent of each other (e.g., do not share nodes). The trained first model may be used to search for the target augmentation task sequence in such a way that the target augmentation task sequence is suitable for the target data. The network structure of the first model and its implementation are described below. In other words, the first model may be applied to a plurality of preset augmentation tasks to find a series (sequence) of target augmentation tasks, from among the plurality of preset augmentation tasks, that are suited to (or fit) the target data.

FIG. 2 illustrates example augmentation tasks, according to one or more embodiments.

As shown in FIG. 2, the augmentation tasks for the case image data may include “no task” (i.e., an identity task that does not change an image) 210, rotation 220, scale 230, contrast 240, saturation 250, and blur 260. The “no task” task indicates that no augmentation is performed on a test image and the test image is maintained. When the data type of the target data is image data, a preset augmentation task may be any image processing operation and the present disclosure is not limited thereto. For example, the preset augmentation tasks may be operations typically found in an image processing pipeline. When the data type of the target data is audio data, the preset augmentation tasks may include, for example, noise reduction, compression, speed increase and decrease, and the like.

The processing of the target data to find the target augmentation task sequence may be performed using cascade iterations; the implementation of the cascade iterations may cascade and finally output the target augmentation task sequence suitable for the target data. Optionally, the cascade iteration process may be implemented through a model including a third network (a recurrent neural network (RNN)), and this may increase an effect of augmentation search policy with a lighter and more efficient network structure.

The first model may be implemented as a cascade loss prediction model or a cascade loss predictor.

In operation 103, the data processing device may generate augmented data from the target data based on the final/outputted target augmentation task sequence.

Specifically, the target augmentation task sequence (determined in operation 102) may be applied to each target data item (e.g., a target image) to obtain a corresponding augmented target data item (e.g., an augmented version of the target image). In this operation, augmented versions of pieces of the target data may be obtained, which may obviate any need to obtain additional test data.

In operation 104, the data processing device may obtain a prediction result corresponding to the target data by inputting the augmented target data to the trained second model and performing a corresponding process (inference) on the augmented target data.

Specifically, the data processing device may obtain a final prediction result of the target data by inputting the augmented target data to the trained second model. Optionally, when the second model is suitable for another processing task, the data processing device may obtain a final prediction result by training a neural network corresponding to the processing task. For example, in a case of an image classification task, the second model may be a classifier. When the augmented target data is input to a trained classifier, a classification result corresponding to the target data may be obtained. The second model may also be referred to as a target model.

In examples herein, a data processing method may include adapting the need of augmentation, expanding a search space and upper bound of an augmentation task, and searching for a more suitable augmentation task in a test operation, thereby improving prediction performance of the second model when it performs prediction on the augmented target data.

In an example of data augmentation processing that is for image data, the trained second model and an input image (e.g., a test image) may be provided, and accordingly, a loss value from different augmentation samples may accurately show quality of the respective predefined augmentation tasks used to generate the augmentation samples. Accordingly, selecting the test operation augmentation using this accurate loss value may be a more direct approach. To increase efficiency, the data processing device may search for a suitable augmentation task based on a loss predictor. The first model may independently predict loss values respectively corresponding to the predefined augmentation tasks. The input image is not directly input to the second model, rather, augmented data augmented through an augmentation task having a lowest prediction loss value may be inputted to the second model.

The loss predictor is used to determine an augmentation task for achieving best performance for the second model. An output of the loss predictor may show quality ranking of the augmentation task, thereby exhibiting advantages of an integration effect. The data processing device may set k as the preset number of tasks, and select k predefined augmentation tasks corresponding a lowest value for the integration (i.e., may select the k best predefined augmentation tasks). In addition, the data processing device may be implemented as a module in which preprocessing of an input sample is at a significantly light level due to complete separation between the second model and the loss predictor. Based on this, the data processing method use the EfficientNet-B0 network with multi-level feature modification as a backbone of the loss predictor.

EfficientNet-B0 is a convolutional neural network and is trained with 1 million or more images of the ImageNet database. EfficientNet-B0 classifies images into thousands of object categories, such as a keyboard, mouse, pencil, various animals, and the like.

In order to process a severely corrupted test sample, the data processing device may process the test sample using a loss predictor of cyclic iteration. The data processing device may introduce cyclic TTA to the loss predictor in a cyclic manner. Since a single loss predictor predicts a loss for only one augmentation task at a time, an augmented image may be processed by the second model while the cyclic TTA performs multiple reuses of the loss predictor. As noted, the loss predictor is an individual version (predicts loss for only one augmentation task at a time), and thus the augmented image is used as an input in another cycle (iteration). Thus, for each test sample: the data processing device may continue repeating the iteration having three steps (prediction loss, augmentation selection, and image augmentation) until a termination signal is activated. When either of two conditions is met the cycle of iterations may be broken. One condition is the “no task” (identity task) being predicted as an optimal augmentation task, and the other condition is reaching a predetermined upper bound number of iterations. The former condition indicates that a current image is in an optimal state and the latter condition prevents endless prediction. The maximum number of iterations is a hyperparameter, but excessive iterations may be suppressed more in the multi-loss prediction. Since the data processing device may use, as a lightweight backbone, EfficientNet-B0, the cyclic TTA cost of the second model may be negligible, even when the loss predictor is executed several or more times. However, in the cyclic TTA, it is still may be required to iteratively call the loss predictor, and the lightweight backbone network may have limited performance to some extent.

The method of training the loss predictor may be generally the same for both the single augmentation method and the cyclic augmentation method. Even when the loss predictor is trained, the second model may remain fixed. Initially, the data processing device may predefine N augmentation tasks, including the “no task” task. When an input image is given/selected, the data processing device inputs each of N corresponding augmented samples/images to the second model to obtain N cross-entropy loss values. After collecting the N loss values, the data processing device may finally generate an actual value of the loss predictor by applying a SoftMax function for transforming the N loss values to a probability. More specifically, the data processing device may calculates Spearman-related rank loss with a target function for optimization. Accordingly, the loss predictor learns a method of aligning qualities of predefined augmentation tasks to select a suitable augmentation task during a test. Also, training and validation data of the loss predictor may be taken from the training data of the second model to increase usability of the method.

As the data space expands, the performance of the loss predictor also improves. A relative loss value of such virtual loss prediction is accurate, and the test sample may be increased through an augmentation task with the least loss. The performance thereof may simulate an upper bound of the loss predictor. The cyclic TTA shows that longer iteration may lead to higher performance and may provide more potential for improvement.

The advantage of the cyclic TTA becomes apparent when performing multiple augmentation iterations on a single test sample. Among the example methods described herein, the focus is on a method of generating a series of target augmentation tasks using a single network. Proposed cascade TTA captures semantic information of an augmented image in each iteration using an RNN, and realizes an augmentation task of prediction iteration without necessarily using an intermediate augmented image.

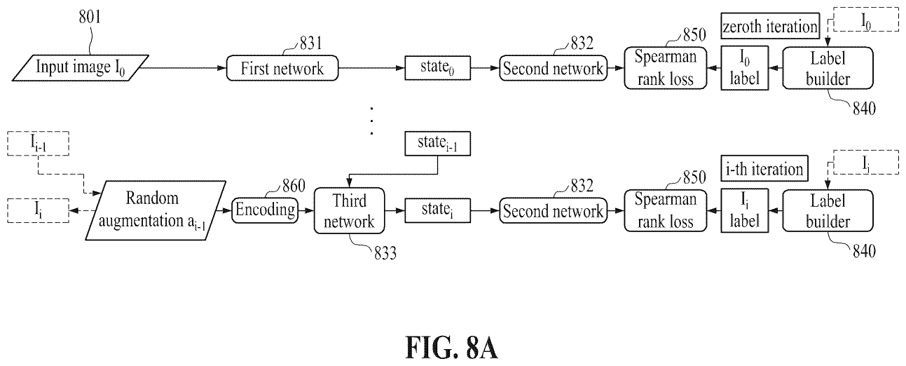

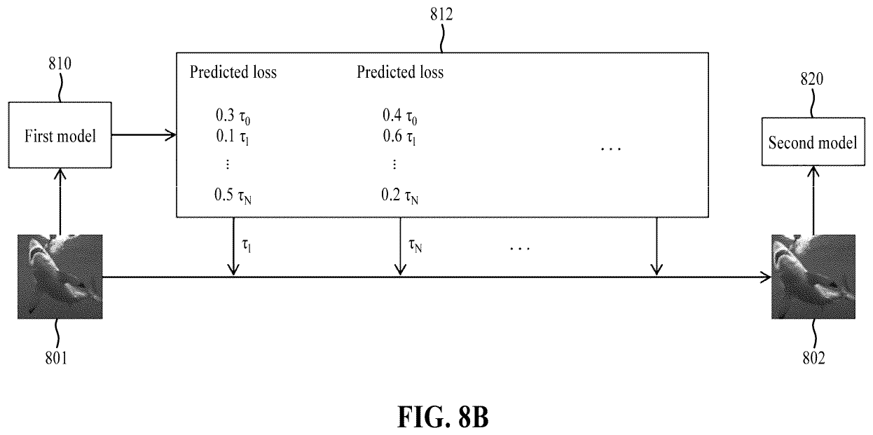

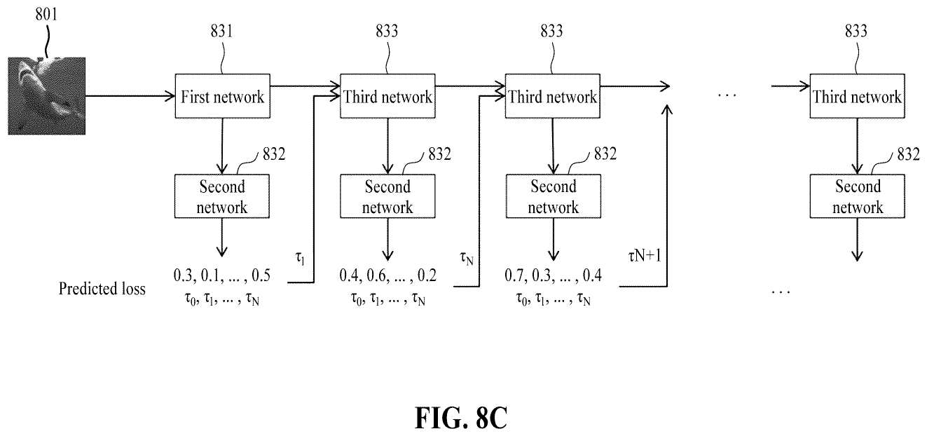

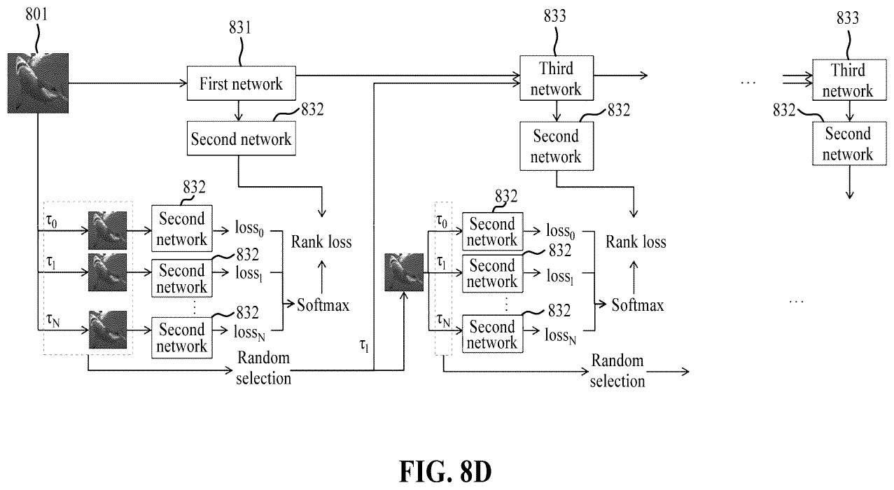

FIG. 8A illustrates an example of training a first model 810 in a data processing device, according to one or more embodiments. FIG. 8B illustrates another example of training the first model 810 in a data processing device, according to one or more embodiments. FIG. 8C illustrates still another example of training the first model 810 in a data processing device, according to one or more embodiments. FIG. 8D illustrates still another example of training the first model 810 in a data processing device, according to one or more embodiments.

8B illustrates a cascade-TTA process during a test. At this time, only one forward propagation of a cascade loss predictor, which is a first model 810, is performed to iteratively obtain a plurality/sequence of target augmentation tasks. Without requiring the cost of inputting the augmented image to the loss predictor again, a new cascade network 812 receives only an original input 801 but provides a series of suitable target augmentation tasks. In this case, in examples herein, a target augmentation task sequence may be obtained by executing it once, and may directly generate a final augmentation sample 802 that is to be input to a second model 820.

As shown in FIG. 8C, an RNN unit (a third network 833) may process dependencies through the cascade loss prediction. Some implementations described herein involve an RNN-based rational cascade loss predictor to generate the target augmentation task sequence. The cascade loss predictor may include three parts; a backbone network (a first network 831), an RNN unit (the third network 833), and an output unit (a second network 832).

In examples herein, searching for a target augmentation task suitable for the target data through the loss prediction method is an effective search policy for test operation augmentation. Additional details of the determining of the target augmentation task sequence is described next.

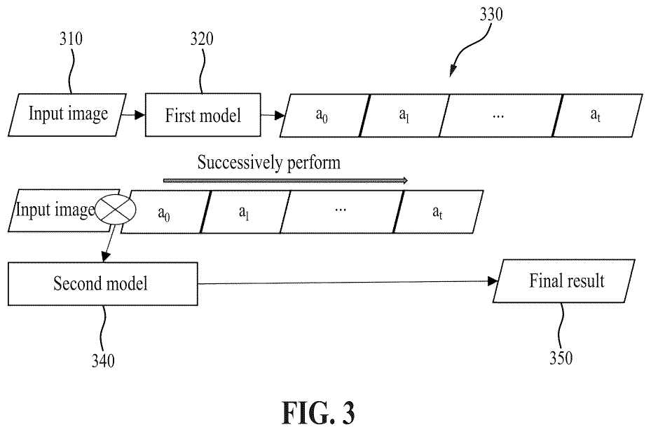

FIG. 3 illustrates an example of testing in a data processing device, according to one or more embodiments.

As shown in FIG. 3, the data processing device may proceed with cascade iteration processing for target data through a trained first model 320 (e.g., first model 810). The data processing device inputs target data (e.g., an input image 310 shown in FIG. 3) to the first model 320, proceeds with the cascade iteration processing for the target data by the first model 320, and finds a target augmentation task sequence/order suitable for the target data, shown in FIG. 3 as {a₀, a₁, . . . , aₜ} 330.

Then, the data processing device may obtain a final result 350 by providing the input image 310 and {a₀, a₁, . . . , aₜ} 330 to a second model 340.

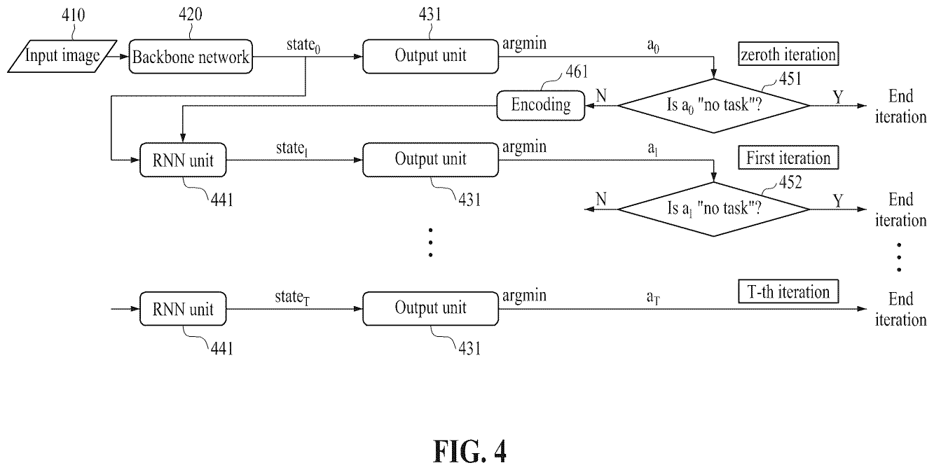

FIG. 4 illustrates an example of processing by a first model in a data processing device, according to one or more embodiments. “First model” refers to the collection of elements shown in FIG. 4.

Specifically, as shown in FIG. 4, the first model includes a first network (e.g., a backbone network 420) for determining/extracting a state feature from an input target data item (e.g., input image 410), a second network (e.g., output unit 431) for determining a target augmentation task corresponding to a next iteration based on a state feature of the next iteration, and a third network (e.g., RNN unit 441) for determining the state feature of the next iteration based on the state feature of the current iteration and the target augmentation task corresponding to the current iteration (as used herein, “network” means “neural network”).

As noted, the first network may be a backbone network 420 that has a network structure related to deep learning technology and therefore details thereof (e.g., layers, nodes, connections between layers/nodes, weights of connections, etc.) are not described herein. As shown in FIG. 4, the first network may extract a state feature state₀ of target data (e.g., an input image 410 shown in FIG. 4) in an initial iteration (i.e., zeroth iteration) of the overall first model.

The second network may include an output unit 431. The output unit 431, also a part of the first model, may perform tasks such as reshaping, pooling, linear transformation, and SoftMax of the state feature state₀, however, the tasks may be flexibly adjusted according to implementation of the first network (which may vary), and the present disclosure is not limited thereto. The output unit 431 may be implemented as a neural network.

The third network may be an RNN (may include RNN unit 441) having the same general function (e.g., same type of input and same type of output, but not the same logic) as the first network of the first model, and may be used to determine, one at a time, state features of the respective iterations. However, an input of the third network is different from that of the first network; the input of the third network is a state feature of a current iteration and a target augmentation task (encoded information) of the current iteration. The state feature of the current iteration may be used as a hidden state, and the target augmentation task of the current iteration, in the form of having been encoded through encoding 461, may, as noted, be used as another input to the third network.

Referring to FIG. 4, in operations 451 and 452 (zeroth and first iterations), the data processing device may determine whether target augmentation tasks of the respective iterations are “no task”.

Next, training of the first model will be described in association with the network structure of the first model.

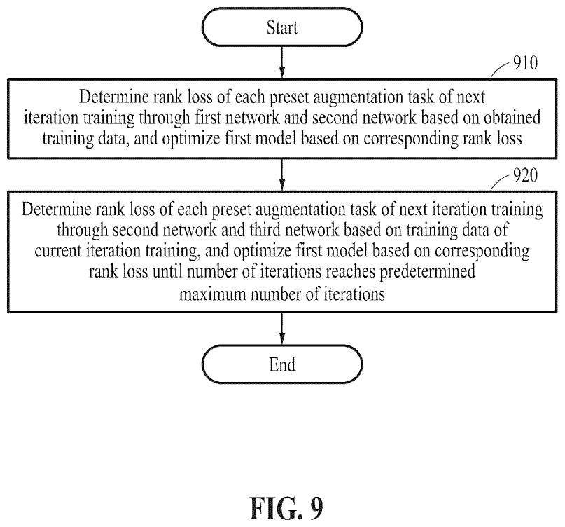

FIG. 9 illustrates an example of training a first model in a data processing device, according to one or more embodiments.

Referring to FIG. 9, in operation 910, in a representative current training iteration, the data processing device may determine rank losses the predefined augmentation tasks of the next training iteration through a first network and a second network based on obtained training data, and optimize a first model based on a corresponding rank loss (e.g., a rank loss from applying SoftMax to the rank losses of operation 910). Rank loss generally refers to a statistical dependence between the rankings of augmentation tasks.

In operation 920, the data processing device may determine rank losses of the respective predefined augmentation tasks of the next training iteration through the second network and a third network based on training data of the current training iteration, and optimize the first model based on a corresponding rank loss (e.g., based on a SoftMax of the individual rank losses of operation 920), which may be repeated until the number of iterations reaches a predetermined maximum number of iterations.

Specifically, as shown in FIGS. 8A to 8D, the training of the first model may be divided into (i) a first part that is implemented by the first network 831 and the second network 832, and (ii) a second part that is implemented by the second network 832 and the third network 833 (such “dividing” being for the purpose of describing a general process of cascade iteration).

As shown in FIG. 8A, in the training of each iteration, the output of the second network 832 is combined with a label (ground-truth) output from a label builder 840 (e.g., an image-label database, a high-accuracy image classification network, etc.), and a rank loss of each augmentation task is calculated through a Spearman rank loss, thereby completing one iteration training, for example, an initial iteration training. That is, the data processing device may optimize the first model with the zeroth iteration.

At this time, the training implemented by the first network 831 and the second network 832 processes the obtained training data, that is, the first network 831 processes original training data during training. The training implemented by the second network 832 and the third network 833 processes training data of the current iteration, that is, a feature input during training of the third network 833 includes a feature obtained in the current iteration training.

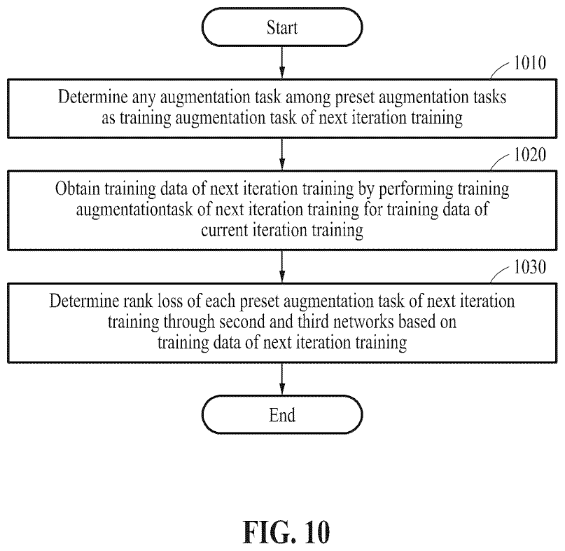

Optionally, operation 920 of FIG. 9 may include operations of FIG. 10. Here, “optionally” does not imply that any other step described herein is not optional; optionality of a step or operation depends on the context thereof.

FIG. 10 illustrates an example of determining rank losses of the respective predefined augmentation tasks of a next iteration through second and third networks in a data processing device, according to one or more embodiments.

Referring to FIG. 10, in operation 1010, the data processing device may determine (select, e.g., randomly) any augmentation task among the predefined augmentation tasks as a training augmentation task of the next iteration training.

In operation 1020, the data processing device may obtain training data of the next training iteration by performing the selected training augmentation task (of the next iteration training) on the training data of the current training iteration.

In operation 1030, the data processing device may determine the rank losses of the respective predefined augmentation tasks of the next training iteration by the second and third networks performing inference on the training data of the next training iteration.

In examples, as shown in FIGS. 8A to 8D, the training implemented by the first network 831 and the second network 832 corresponds to the zeroth iteration, and the training implemented by the second network 832 and the third network 833 corresponds to a first iteration to an i-th iteration, that is, the number of iterations in the training stage may be set to L iterations. With this in view, starting with the first iteration, the third network 833 may exhibit the same type of function as the first network 831, and each training iteration implemented by the second network 832 and the third network 833 may randomly allocate the augmentation task to achieve diversity of data in the training stage. As shown in FIGS. 8A to 8D, during the first training iteration, I₁ is first obtained by proceeding with randomly allocated augmentation a₀ for I₀ (zeroth iteration) and a label for iteration I₁ obtained using the label builder 840. Then, state₀ and the encoding of a₀ are provided to the RNN unit (the third network 833) to obtain the hidden state state₁ of this round, and a Spearman rank loss 850 is used again through the second network 832 for optimization.

Hereinafter, the label builder will be described in detail.

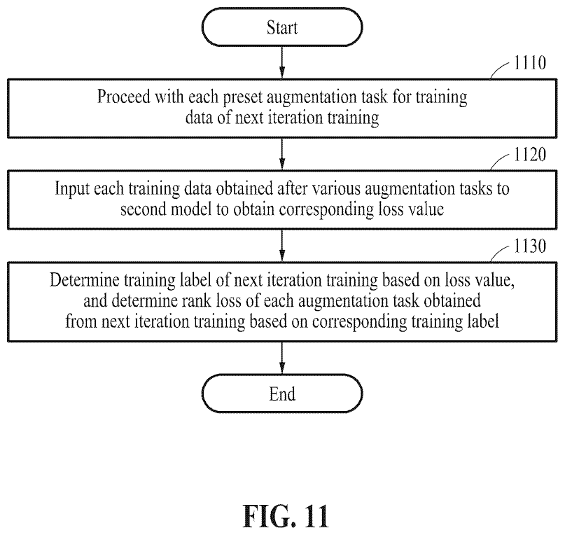

Optionally, operations 910 and 920 of FIG. 9 may include operations of FIG. 11 below.

FIG. 11 illustrates an example of determining a rank loss of predefined augmentation tasks of a next iteration in a data processing device, according to one or more embodiments.

In operation 1110, the data processing device may proceed with each predefined augmentation task for the training data of the next training iteration.

In operation 1120, the data processing device may input each training data obtained after various augmentation tasks to a second model to obtain a corresponding loss value.

In operation 1130, the data processing device may determine a training label of the next iteration training based on the loss value, and determine a rank loss of each augmentation task obtained from the next iteration training based on the corresponding training label.

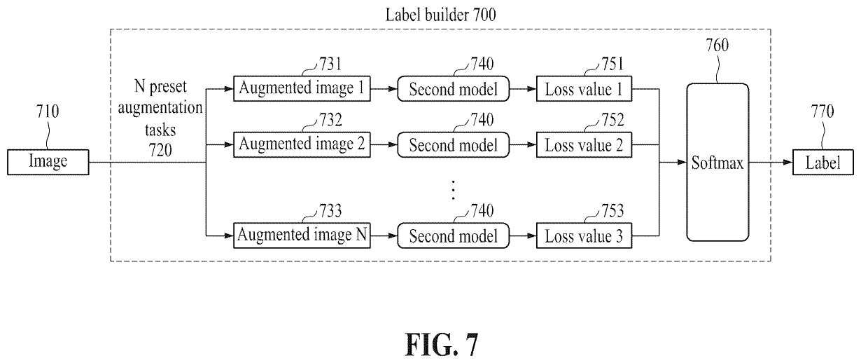

FIG. 7 illustrates an example configuration of a label builder of a data processing device, according to one or more embodiments.

Specifically, as shown in FIG. 7, a label builder 700 may first augment data for a training data item (an input image 710) of a next training iteration based on N predefined augmentation tasks to obtain N respective augmented images, that is, an augmented image 1 (731), an augmented image 2 (732), . . . , and an augmented image N (733).

Then, the label builder 700 may obtain N loss values {loss_{0,1}, loss_{0,2}, . . . , and loss_{0,N}} 751, 752, and 753 output by a second model 740 by inputting each of the corresponding N augmented images to the second model 740. A training label 770 corresponding to the image 710 may then be generated by normalizing (e.g., SoftMax 760) the N loss values 751, 752, and 753.

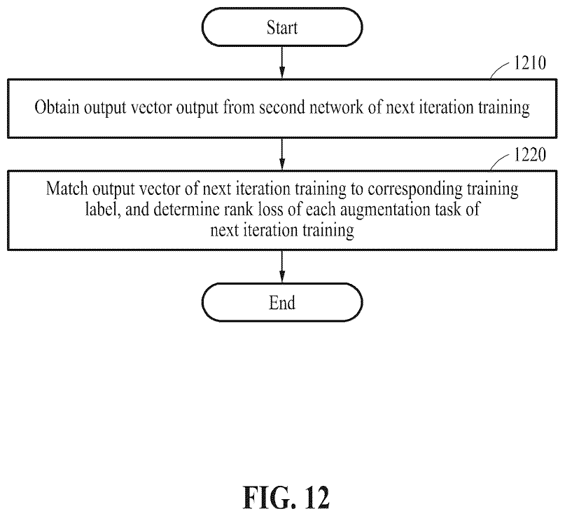

Optionally, operation 1130 of FIG. 11 may include operations of FIG. 12 below.

FIG. 12 illustrates an example of determining rank losses of respective augmentation tasks obtained for a next training iteration based on a corresponding training label in a data processing device.

Referring to FIG. 12, in operation 1210, the data processing device may obtain an output vector output from the second network of the next iteration training.

Then, in operation 1220, the data processing device may match the output vector of the next training iteration to the corresponding training label, and determine the rank losses of the respective augmentation tasks of the next training iteration.

Specifically, as shown in FIGS. 8A, 8B, 8C, and 8D, the data processing device may calculate a loss of each training iteration by matching the output vector to the training label in a training operation. That is, the data processing device may match an output vector output from the second network 832 to the loss value in the target model after passing through N predefined augmentation tasks on the target data.

Optionally, in the example of the training part, the data processing device may set the maximum number of iterations to L. The data processing device may optimize the first network 831 of the first model and the second network 832 cooperating with the first network 831 in the zeroth training iteration. The data processing device may optimize the third network 833 of the first model and a part of the second network 832 cooperating with the third network 833 in the first to the (L−1)-th training iterations. When the data processing device sets the maximum number of iterations to L, it may be understood that the first model includes one first network 831, (L−1) third networks 833, and L second networks 832.

Next, each task operation related to the training part of the first model is described with specific examples.

As an example, training data of the first model is described as a training image. Specifically, the operations of the training part of the first model are as below.

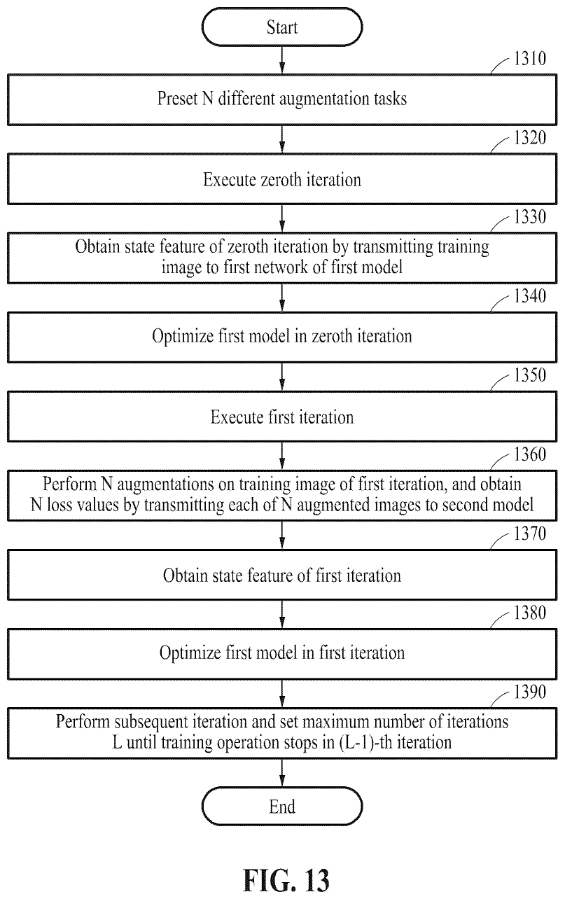

FIG. 13 illustrates an example of training a first model in a data processing device, according to one or more embodiments.

Referring to FIG. 13, in operation 1310, the data processing device may set, configure, etc., N different augmentation tasks.

Then, the data processing device obtains N augmented images {I_{0,1}, I_{0,2}, . . . , and I_{0,N}} by performing N augmentations on the training image I₀, and obtains N loss values {loss_{0,1}, loss_{0,2}, . . . , and loss_{0,N}} by providing each of the obtained N augmented images to the second model. In operation 1320, the data processing device combines the N loss values into a vector and maps the vector using a SoftMax function, for example, to a loss value v₀ (e.g., a probability) of the zeroth iteration training. Generally, operation 1320 is the execution of the zeroth iteration.

In operation 1330, the data processing device obtains a state feature state₀ of the zeroth iteration by transmitting training image I_{0,0} to the first network of the first model.

In operation 1340, the data processing device obtains an output vector p₀ by transmitting the state feature state₀ to the second network, and optimizes the first model by using a Spearman rank loss and matching the output vector p₀ to v₀ by a training label.

In operation 1350, the data processing device randomly designates one augmentation task a₀ among N augmentations, and obtains a training image I_{1,0} of a first iteration (next after the zeroth) by augmenting the training image I_{0,0} by the corresponding a₀ method. Operation 1350 is the execution of the first iteration.

Then, the data processing device obtains another N augmentation images {I_{1,1}, I_{1,2}, . . . , and I_{1,N}} by performing the N augmentations on the training image I_{1,0} of the first iteration. N loss values {loss_{1,1}, loss_{1,2}, . . . , and loss_{1,N}} by are obtained by providing each of these N augmented images to the second model. In operation 1360, the data processing device combines these N loss values into a vector having a length of N and maps the vector SoftMax loss value v₁ using, for example, the SoftMax function.

In operation 1370, the data processing device obtains a state feature state₁ of the first iteration by inputting both the state feature state₀ and the encoding of a₀ to an RNN unit as a hidden state and an input, respectively.

In operation 1380, the data processing device obtains an output vector p₁ by providing state₁ to the second network. The first model is then optimized by using the Spearman rank loss and matching the output vector p₁ to v₁ by the training label.

In operation 1390, the data processing device repeats the subsequent iteration as described above, and sets the maximum number of iterations L until the training operation stops at the (L−1)-th iteration.

In FIGS. 8B and 8C, a branch τ₁ corresponds to a loss value predicted in the zeroth iteration, and a branch τ_{N} corresponds to a loss value predicted in the N-th iteration. In the branch τ₁, 0.3τ₀, 0.1τ₁, . . . , and 0.5τ_{N} are N loss values corresponding to the zeroth iteration. In the branch τ_{N}, 0.4τ₀, 0.6τ₁, . . . , and 0.2τ_{N} are N loss values corresponding to the N-th iteration.

Next, the test part of the first model is described.

First, a primary processing (zeroth iteration) of the target data through the first network and the second network of examples herein will be described in detail.

Specifically, the data processing device may determine a target augmentation task (corresponding to the primary processing of the target data) from among a plurality of preset augmentation tasks using the first network and the second network.

At this time, as shown in FIG. 4, in the primary processing (the zeroth iteration), the first model may determine a target augmentation task suitable for the target data using the first network and the second network.

Optionally, the determining of the target augmentation task from among the plurality of predefined augmentation tasks using the first network and the second network may specifically include the following operations. The data processing device determines the state feature of the primary processing of the target data through the first network. Also, the data processing device may determine an output vector for the next iteration based on the state feature primarily processed through the second network. In addition, the data processing device may determine the target augmentation task corresponding to the next iteration of the target data by satisfying the output vector of the next iteration for an augmentation task corresponding to the preset condition.

Specifically, during the primary processing (i.e., the zeroth iteration), as shown in FIG. 4, an input image I₀ (410) may be transmitted to the first network (e.g., the backbone network 420) to obtain a state feature of I₀, and this may be considered as a hidden state state₀ of the third network (e.g., the RNN unit 441). The second network (e.g., the output unit 431), as a part of the first model, may perform operations on the state feature state₀, which may include operations such as reshaping, pooling, linear transformation, and normalization (SoftMax), and specifically, may be flexibly adjusted according to different configurations of the first network.

If the preset condition is the determining of the target augmentation task in one iteration, based on the output vector output by the second network proceeding with the N augmentations of the input image I₀ (410) and matching to a loss value in the second model, the data processing device may determine that the augmentation task a₀ corresponding to a position of a minimum value (a variable value that may be determined by an argmin function, that is, a variable value when the output vector becomes minimum) of the corresponding output vector is an augmentation task that may be applied to I₀.

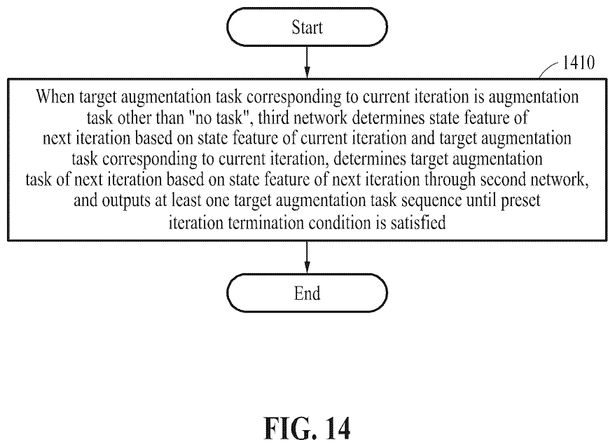

In an implementable example, operation 102 may include an operation of FIG. 14 below.

FIG. 14 illustrates an example of obtaining a target augmentation operation sequence in a data processing device, according to one or more embodiments.

Referring to FIG. 14, in the data processing device, in operation 1410, when a target augmentation task corresponding to the current iteration is determined to not be the “no task” (identity) task, the third network may determine a state feature for a next iteration based on the state feature of the current iteration and the target augmentation task corresponding to the current iteration, determine a target augmentation task of the next iteration based on the state feature of the next iteration using the second network, and output at least one target augmentation task sequence until the iteration termination condition is satisfied.

Specifically, as shown in FIG. 4, the RNN unit 441 of the first model starts from the first iteration. Unlike a simple cyclic iteration, an algorithm of examples herein may not need to perform a₀ augmentation (that is, generation of a test image I₁) of the test image (the input image 410) I₀ in a true sense, and instead, the algorithm may transmit the test image I₀ to the RNN unit 441 using the state feature state₀ and encoded a₀. The output state feature state₁ is sufficient to represent a feature of the test image I₁. Therefore, when the state feature state₁ is directly transmitted to the second network (the output unit 432), the data processing device may obtain the target augmentation task a₁ suitable for the test image I₁, and then obtain secondary augmentations {a₀ and a₁} suitable for the test image I₀.

The data processing device may also proceed with the subsequent operation as described above, and terminate the iteration when one of the two conditions for the iteration termination is satisfied. The test image I₁ may be considered as an augmented version of the test image I₀.

Optionally, the iteration termination condition includes the following two conditions. Iteration termination condition 1: A case in which the target augmentation task corresponding to an arbitrary (current) iteration is the “no task” task (a case in which there is no operative augmentation task). In this case, it may imply that the corresponding target data has already reached an optimal state and no further augmentation is required. Iteration termination condition 2: A case in which the number of iterations reaches the preset maximum number of iterations. In this case, the data processing device may set the maximum number of iterations according to various resource/accuracy requirements, and may ultimately obtain a plurality of augmentations more suitable for the target data, because a calculation amount may be effectively limited.

In examples herein, when the target data is processed through a cascade iteration method, the data processing device may effectively expand the search space of the augmentation policy.

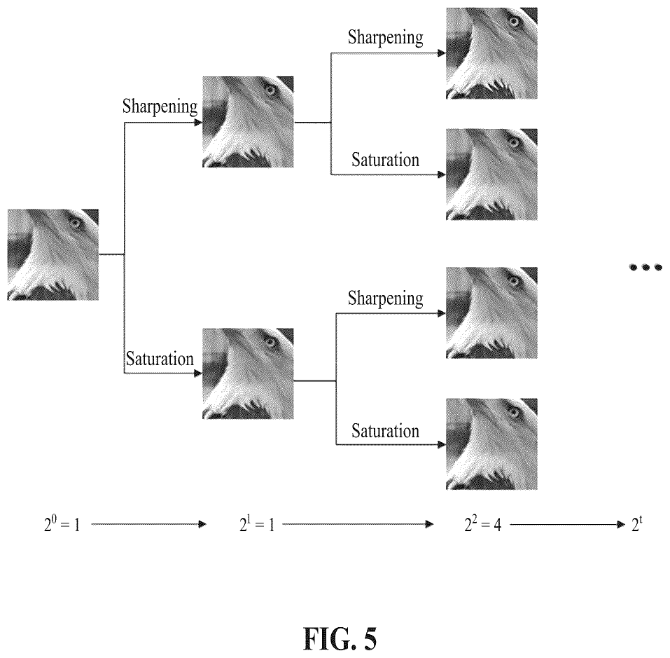

FIG. 5 illustrates an example of a search space expanded in a data processing device, according to one or more embodiments.

As shown in FIG. 5, in an example in which the target data is a test image, if it is assumed that N (the number of predefined augmentation tasks) is 2, (e.g., sharpening and saturation), a single iteration of an algorithm of related technology learning loss for test-time augmentation (L2T) has an augmentation policy search space for only two types (the sharpening and saturation). However, with the cascade iteration techniques described herein, a space capacity increases exponentially as the number of iterations increases. For example, when the number of iterations is two, the search space of the augmentation policy grows into four types: sharpening-sharpening, sharpening-saturation, saturation-sharpening, and saturation-saturation. In this way, when the number of iterations is t, the size of the search space increases to 2^{t}. An increase in space capacity/size may lead to an upper bound increase in TTA method effectiveness, where the upper bound relates to the TTA method correctly selecting augmentation suitable for each image of a test set to improve a prediction effect.

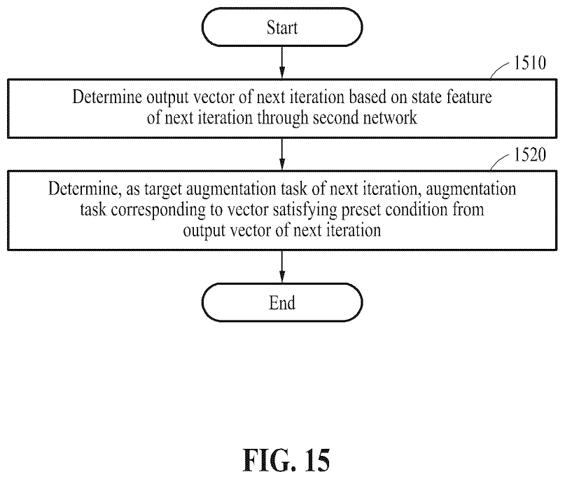

Optionally, operation 1410 of FIG. 14 may include operations of FIG. 15 below.

FIG. 15 illustrates an example of determining a target augmentation task of a next iteration based on a state feature of the next iteration through a second network in a data processing device, according to one or more embodiments.

Referring to FIG. 15, in operation 1510, the data processing device may determine an output vector of the next iteration based on the state feature of the next iteration, and may do so using the second network.

In operation 1520, the data processing device may determine, as the target augmentation task of the next iteration, an augmentation task corresponding to a vector satisfying the preset condition in the output vector of the next iteration.

Specifically, in the data processing device, during the process of the cascade iteration, the second network may output the output vector of the next iteration based on the state feature of the next iteration. As in the training description above, it may be understood that the output vector of the second network corresponds to performing of the N predefined augmentation tasks, and then a loss value of the target data is fitted in the target model. Therefore, it may be determined that an augmentation task corresponding to a position (element) in the output vector satisfying the preset condition is suitable for the target data. When the preset condition is determined as only one target augmentation task in one iteration, the data processing device may determine the augmentation task corresponding to the position of a minimum value in the output vector as the corresponding target augmentation task. When the preset condition is to determine M target augmentation tasks (M is a positive integer greater than 1) as one iteration, the data processing device may determine, as the corresponding target augmentation tasks, the augmentation tasks corresponding to the M minimum values in the vector (when the M target augmentation tasks are determined as one iteration).

In an implementable example, the data processing device may determine a plurality of target augmentation tasks in each iteration, and various related situations are described next.

Situation 1: Each iteration determines a target augmentation task.

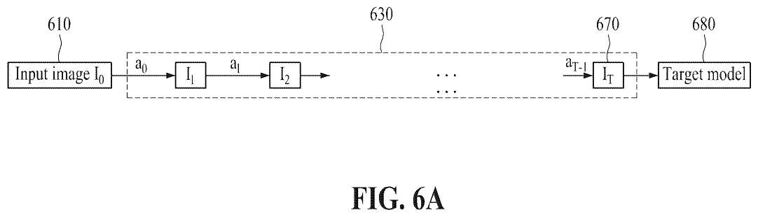

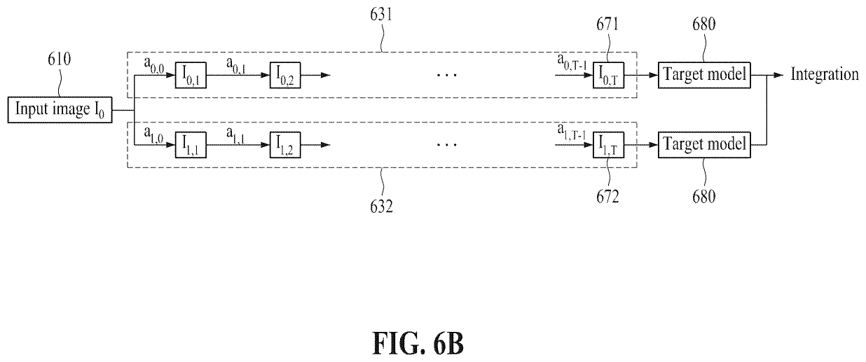

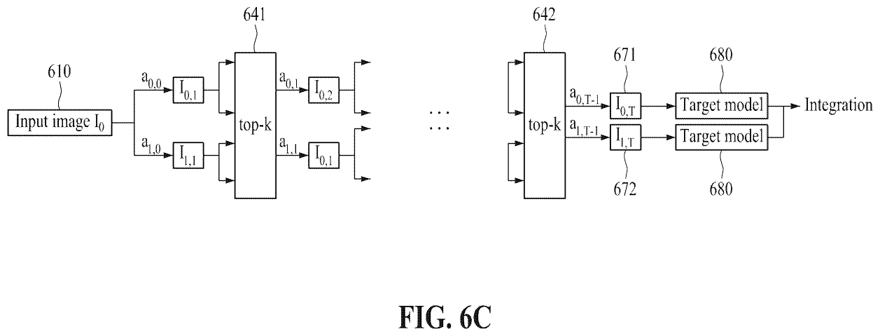

FIG. 6A illustrates an example of testing in a data processing device, according to one or more embodiments.

As shown in FIG. 6A, the data processing device determines only one target augmentation task applicable to an input image 610 which is target data for each iteration in the entire test operation. In the implementation of the method, there is only one iteration branch 630, and one target augmentation task sequence is ultimately output. The data processing device may provide an image I_{T} augmented by the target augmentation task sequence to a target model which is the target model 680.

Situation 2: When the number of determined target augmentation tasks in the current iteration is N (greater than 1), the data processing device determines a state feature of the next iteration for each target augmentation task and the state feature of the current iteration. Then, the data processing device determines a target augmentation task of the next iteration based on the state feature of the next iteration, and outputs N target augmentation task sequences by sequentially executing the iterations until a preset iteration termination condition is satisfied.

Specifically, when the target augmentation task of the current iteration includes N items, the data processing device proceeds with each next iteration based on each target augmentation task, and the next iteration determines only one target augmentation task. The processing of the corresponding situation finally outputs N target augmentation task sequences.

FIG. 6B illustrates another example of testing in a data processing device, according to one or more embodiments.

As shown in FIG. 6B, in the data processing device, when the number of target augmentation tasks of the first iteration is, for example, K, K parallel branches 631 and 632 may exist. Each of the branches 631 and 632 represents a set of successive cascade target augmentation tasks. For example, in the data processing device, when K is 2, there are two parallel branches 631 and 632, and after T-th iteration, two different successively augmented images I_{0,T} (671) and I_{1,T} (672) may be obtained.

Situation 3: When the number of determined target augmentation tasks in the current iteration is N (greater than 1), the data processing device determines a state feature of the next iteration for each target augmentation task and the state feature of the current iteration. Then, the data processing device determines N augmentation tasks for the next iteration based on the state feature of the next iteration. The data processing device determines a target augmentation task for the next iteration by selecting N augmentation tasks among the determined N*N augmentation operations, and outputs N target augmentation task sequences by sequentially executing the iterations until a preset iteration termination condition is satisfied.

Specifically, when the number of target augmentation tasks corresponding to the current iteration is N, the data processing device may proceed with the next iteration based on each target augmentation task. The data processing device may determine each of N augmentation tasks for the next iteration. In this case, the next iteration may include a total of N*N augmentation tasks. The data processing device may maintain N items (which coincides with the number of items of the target augmentation task of the current iteration) as the target augmentation task of the next iteration in the corresponding N*N augmentation task, in order to prevent an increase of a computational workload due to an increase of the number of iterations. The processing of the corresponding situation finally outputs N target augmentation task sequences.

FIG. 6C illustrates still another example of testing in a data processing device, according to one or more embodiments.

As shown in FIG. 6C, in the data processing device, when the current iteration is the zeroth iteration and the number of target augmentation tasks in the first iteration is K, K optimal augmentation tasks are selected for each iteration (641, 642) (FIG. 6C shows an example in which K is 2). In the example shown in FIG. 6C, the data processing device may effectively prevent an increase in parallel branches and an excessive amount of calculation as the number of iterations increases by using a beam search starting from the first iteration. Specifically, the data processing device may obtain two branches by selecting two target augmentation tasks in the zeroth iteration. When two target augmentation tasks are selected for each branch in the first iteration, the first iteration includes four target augmentation tasks in total, and four branches are subsequently obtained. Accordingly, the data processing device may select two optimal target augmentation tasks among the four target augmentation tasks as the target augmentation tasks corresponding to the first iteration, thus preventing an increase of the calculation amount. That is, the data processing device may perform subsequent cascade iteration by selecting (641, 642) two branches among four branches, thereby obtaining two different images I_{0,τ} (671) and I_{1,τ} (672) which are successively augmented.

It may be understood that, compared to the example shown in FIG. 6A, in the examples shown in FIGS. 6B and 6C, a series of the target augmentation tasks output by the first model may make the second model more stable and obtain excellent effects in the test operation.

Situation 4: When the number of determined target augmentation tasks in the current iteration is N (greater than 1), the data processing device determines a state feature of the next iteration for each target augmentation tasks and the state feature of the current iteration. Then, the data processing device determines N target augmentation tasks of the next iteration until a preset iteration termination condition is satisfied according to the state feature of the next iteration, and outputs a plurality of target augmentation task sequences.

Specifically, the data processing device may perform the iteration processing in a next iteration for each target augmentation task obtained in a previous iteration, in order to find a target augmentation task that is more suitable for the target data without considering the amount of calculation. Specifically, when N target augmentation tasks are determined in the first iteration and the first iteration includes N iteration branches, the data processing device may proceed with each iteration for each branch. The data processing device may determine N target augmentation tasks for each branch in the first iteration. That is, the data processing device may obtain a total of N*N target augmentation tasks in the first iteration. Then, the data processing device includes N*N iteration branches in a second iteration and outputs a plurality of target augmentation task sequences by repeating the iteration for each branch until the preset iteration termination condition is satisfied.

Situation 3 is equivalent to using bundle search processing based on Situation 4 in order to ensure accuracy of the determined target augmentation task while reducing the amount of calculation.

Optionally, operation 104 of obtaining the prediction result corresponding to the target data by inputting the augmented target data to the trained second model and processing the augmented target data accordingly may include the following operation.

Operation 104 may include, in a case of including a plurality of target augmentation task sequences, obtaining a plurality of output results by inputting each of a plurality of pieces of augmented target data obtained after augmenting the data based on the target augmented task sequences to the second model, and obtaining the prediction result corresponding to the target data by integrating the plurality of output results.

Specifically, as shown in FIGS. 6B and 6C, when the data processing device includes a plurality of branches, each branch outputs a target augmentation task sequence including a plurality of sets of a series of target augmentation tasks finally applicable to the input image I₀. Assuming that the data processing device includes two branches, two sets of target augmentation tasks applicable to the input image I₀ may be included. At this time, two augmented input images (obtained through continuous enhancement) may be included. Then, the data processing device may obtain two output results by inputting the two augmented input images I_{0,τ} and I_{1,τ} to the second model, and then obtain a prediction result for the finally output target data by integrating two output results. In this case, the integration may be an average value of the output results.

Optionally, as shown in FIG. 6A, when only one branch is provided, the data processing device finally outputs one target augmentation task sequence. That is, the data processing device obtains an augmented input image I_{τ} by augmenting a set of input images I₀ by a series of applicable target augmentation tasks, and then obtains a prediction result by transmitting the augmented input image I_{τ} to the second model.

Next, each task operation related to the test part of the first model will be described by combining specific examples.

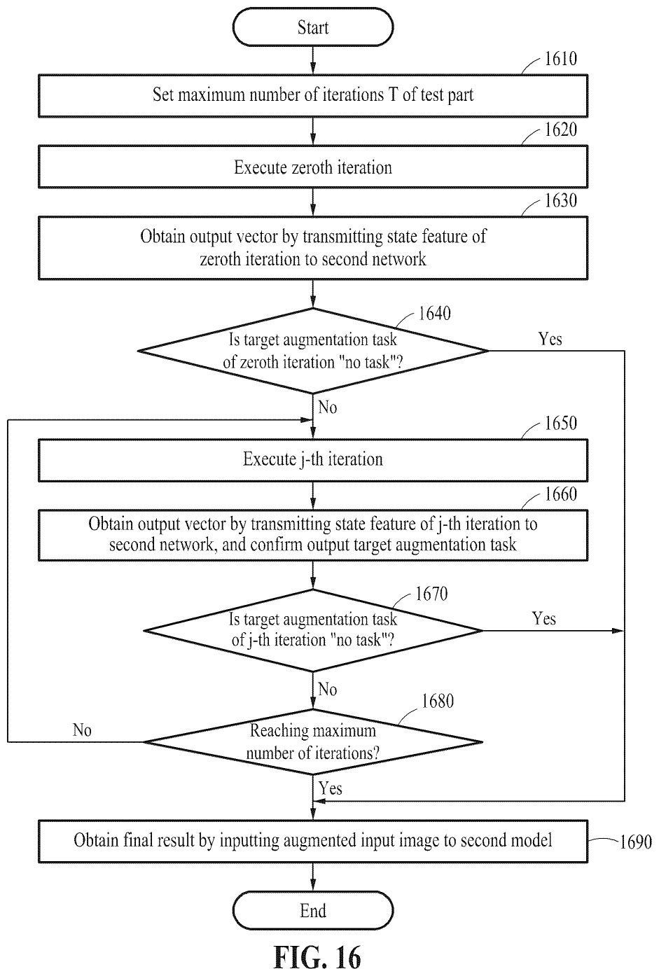

In an example, taking a case where the target data is a test image, the test part of the first model is described with reference to FIG. 16.

FIG. 16 illustrates an example of testing a first model in a data processing device, according to one or more embodiments.

Referring to FIG. 16, in operation 1610, the data processing device presets a maximum number of iterations of the test part to T. It may be understood that the number of iterations T herein and the number of iterations L of the training part do not affect each other. In an example herein, the number of iterations may be flexibly adjusted.

In operation 1620, the data processing device transmits the test image I₀ to the first network of the first model to obtain the state feature state₀ of the zeroth iteration. At this time, operation 1620 corresponds to the execution of the zeroth iteration.

In operation 1630, the data processing device obtains an output vector p₀ by providing the state feature state₀ of the zeroth iteration to the second network. At this time, since the output vector p₀ is suitable for a loss value of the test image I₀ in the second model after N augmentations, an augmentation task corresponding to a position of a minimum value in the output vector p₀ is a target augmentation task a₀ output in the zeroth iteration.

In operation 1640, the data processing device determines whether the target augmentation task a₀ is the “no task” task.

When the target augmentation task is not the “no task” task as a result of the determination in operation 1640, in operation 1650, the data processing device may obtain a state feature stateⱼ of a j-th iteration by transmitting a state feature stateⱼ₋₁ and encoded aⱼ₋₁ of a (j−1)-th iteration to the RNN unit as a hidden state and an input, respectively. At this time, operation 1650 corresponds to the execution of the j-th iteration. In operation 1650, when the j-th is the first, the data processing device may obtain a state feature state₁ of a first iteration by transmitting a state feature state₀ and encoding a₀ of a zeroth iteration to the RNN unit as a hidden state and an input, respectively.

In operation 1660, the data processing device may obtain an output vector pⱼ by transmitting the state feature stateⱼ of the j-th iteration to the second network, and confirm a target augmentation task aⱼ which is an augmentation task corresponding to a position of a minimum value in the output vector pⱼ.

In operation 1670, the data processing device determines whether the target augmentation task aⱼ is “no task”.

When the target augmentation task is not “no task” as a result of the determination in operation 1670, in operation 1680, the data processing device determines whether the number of iterations has reached a maximum number of iterations.

When the number of iterations has not reached the maximum number of iterations as determined in operation 1680, the process returns to operation 1650 and repeats a series of operations. The target augmentation tasks output by every iteration are, in order, {a₀, a₁, . . . , and aₜ}.

When the target augmentation task is “no task” or the number of iterations has reached the maximum number of iterations as a result of the determination in operation 1640 or 1670, in operation 1690, the data processing device obtains Iₜ by continuously performing a series of target augmentation tasks for the original test image I₀, and obtains a final result by providing the obtained Iₜ to the second model.

In order to more clearly describe technical effects that may be achieved by the method of processing data provided in examples herein, a processing situation for setting a data set is described next.

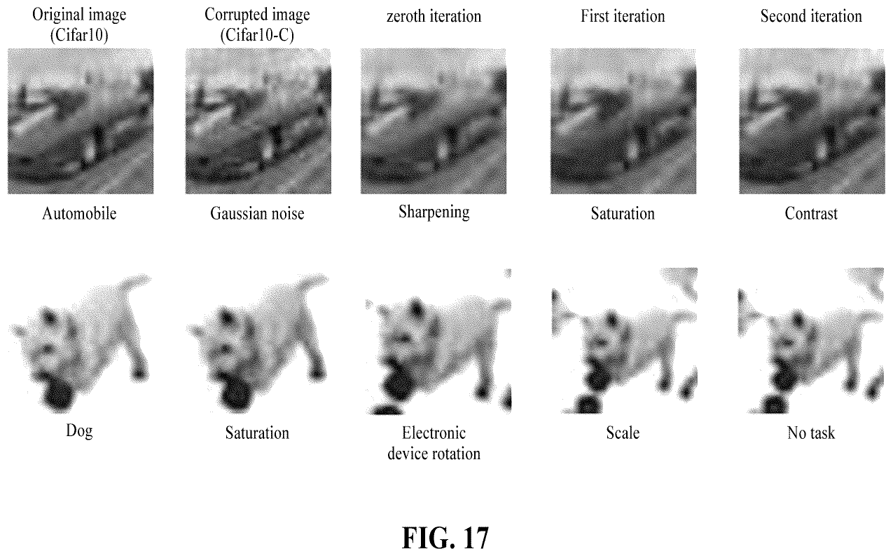

FIG. 17 illustrates an example of a visualization effect of a classification task for a setting data set in a data processing device, according to one or more embodiments.

FIG. 17 shows a visualization effect of a classification task for a setting data set (Cifar10 and Cifar10-c). Referring to FIG. 17, two rows show two respective example images. The first column shows an image of an original Cifar10 data set (a data set used to identify universal objects). The second column shows a corrupted image, and the type of corruption is shown under the image second column's images. For example, a second image in the second column is corrupted by saturation. The last three columns show a cascade augmentation effect after different iterations. With an example of an automobile category of the first row, the image is corrupted after experiencing Gaussian noise and a second model may not be correctly classified. After TTA of a single iteration, that is, after a sharpening augmentation task, there is improvement, however, it is still difficult to identify categories. However, in the present disclosure, when sharpening, saturation, and contrast augmentation are consistently used, image classification is more accurate.

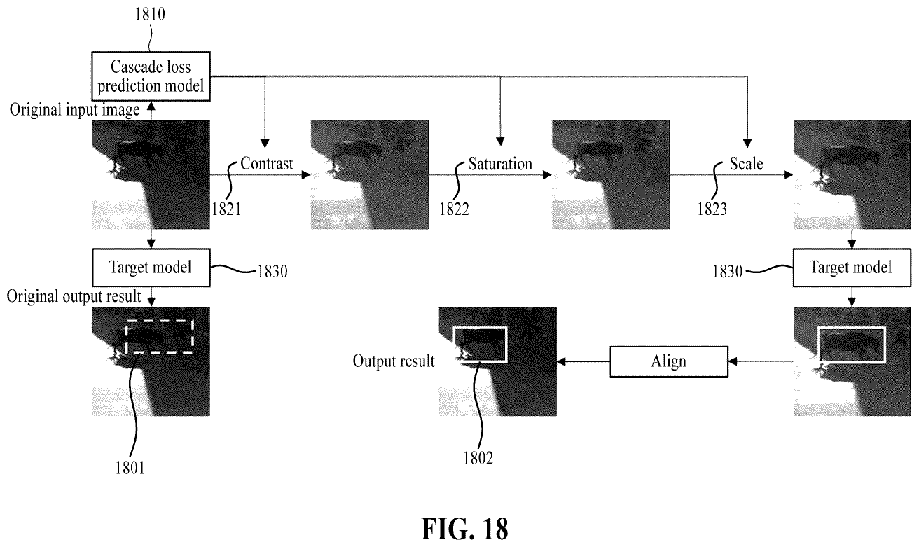

The examples herein may be used for most computer vision tasks as well as the image classification task. An exemplary diagram of a target detection task is shown in FIG. 18.

FIG. 18 illustrates an example of an effect of a target detection task in a data processing device, according to one or more embodiments.

Referring to FIG. 18, when a bull in an image is detected from an original input image using a second model, in this case a target model 1830, the detection of the second/target model 1830 may be inaccurate due to a problem of data distribution drift (a result shown in a white dotted box 1801). However, the data processing device may input the original input image to any of the variety of first models described above, i.e., a cascade loss prediction model 1810, which in this example augments data successively using three augmentation tasks of contrast 1821, saturation 1822, and scale 1823. A more accurate prediction result by inputting the augmented image to the second model which is the target model 1830 (a result shown in a white solid box 1802).

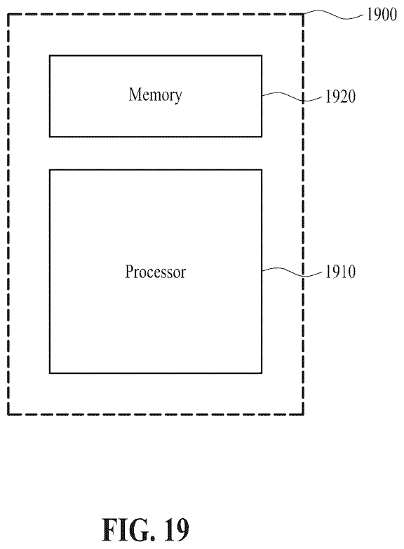

FIG. 19 illustrates an example of a data processing device, according to one or more embodiments.

Referring to FIG. 19, an electronic device 1900 may include a processor 1910 and a memory 1920.

The memory 1920 may be a read-only memory (ROM) or other types of static storage devices capable of storing static information and instructions, a random access memory (RAM) or other types of dynamic storage devices capable of storing information and instructions, and may be an electrically erasable programmable ROM (EEPROM), a CD-ROM, other optical disc storages, an optical disc storage (including a compressed optical disc, laser disc, optical disc, digital versatile disc, Blu-ray disc, etc.), a disc storage medium, other magnetic storage devices, or any other computer-readable media that may be used to transfer or store computer programs, but is not limited thereto. The memory 1920 does not include signals per se.

The memory 1920 may be used to store a computer program for performing the examples herein and controlled by the processor 1910.

The processor 1910 may obtain target data, obtain at least one target augmentation task sequence by processing the target data based on a trained first model, perform data augmentation on the target data according to the target augmentation task sequence, and obtain a prediction result corresponding to the target data by inputting augmented target data to a trained second model and performing a corresponding process on the augmented target data.

The processor 1910 may be configured to execute the computer program stored in the memory 1920 and implement the operations shown in examples of the method described above.

An example herein provides an electronic device including a memory, a processor, and a computer program stored in the memory. The processor may implement operations of the method of processing data by executing the computer program, and implement the followings compared to the related art. When obtaining target data for a test in a test operation, first, at least one target augmentation task sequence including at least two augmentation tasks cascaded by processing target data based on a pre-trained first model is obtained. Then, data may be augmented for the target data based on the corresponding target augmentation task sequence, and a prediction result corresponding to the target data may be obtained by inputting the augmented target data to a trained second model and processing the augmented target data accordingly. In the implementation of the technical solution of the present disclosure, a series of target augmentation tasks corresponding to the target data may be adaptively predicted in a stepwise manner through the cascade iteration processing method of the target data under the premise of not changing the second model, and a more suitable augmentation task may be found by expanding a search space and an upper bound of the augmentation task with lower computational cost. Also, by testing the trained second model based on the augmented target data, a better prediction effect than the existing method may be obtained.

In an optional example, an electronic device may be provided.

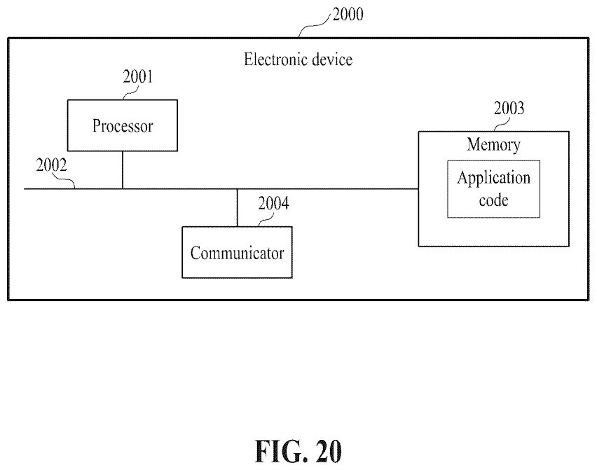

FIG. 20 illustrates an electronic device, according to one or more embodiments.

Referring to FIG. 20, an electronic device 2000 may include a processor 2001 and a memory 2003.

The processor 2001 may be connected to the memory 2003 via, for example, a bus 2002. Optionally, the electronic device 2000 may further include a communicator 2004, and the communicator 2004 may be used for data interaction between the electronic device and another electronic device, such as data transmission and/or data reception. It should be noted that in actual application, the number of the communicators 2004 is not limited to one, and the structure of the electronic device 2000 does not configure a limitation to examples herein.

The processor 2001 may be a central processing unit (CPU), a general-purpose processor, a digital signal processor (DSP), an application-specific integrated circuit (ASIC), a field programmable gate array (FPGA), or other programmable logic devices, a transistor logic device, a hardware component, or any combination thereof. The processor 2001 may implement or execute various exemplary logical blocks, modules, and circuits described herein. The processor 2001 may also be, for example, a combination for implementing a computing function including a combination of one or more microprocessors or a combination of a DSP and a microprocessor.

The bus 2002 may include a path for transmitting information between the components. The bus 2002 may be a peripheral component interconnect (PCI) bus or an extended industry standard architecture (EISA) bus. The bus 2002 may be classified into an address bus, a data bus, a control bus, and the like. For convenience of illustration, only one thick line is shown in FIG. 20, but there is not only one or one type of bus.

The memory 2003 may be a ROM or other types of static storage devices capable of storing static information and instructions, a RAM or other types of dynamic storage devices capable of storing information and instructions, and may be an EEPROM, a CD-ROM, other optical disc storages, an optical disc storage (including a compressed optical disc, laser disc, optical disc, digital versatile disc, Blu-ray disc, etc.), a disc storage medium, other magnetic storage devices, or any other computer-readable media that may be used to transfer or store computer programs, but is not limited thereto.

The memory 2003 may be used to store a computer program for performing the examples herein and controlled by the processor 2001. The processor 2001 may be configured to execute the computer program stored in the memory 2003 and implement the operations shown in examples of the method described above.

The method provided in examples herein may be implemented through an AI model. AI-related functions may be performed by a non-volatile memory, a volatile memory, and a processor.

The processor may include one or more processors. The one or more processors may be, for example, general-purpose processors (e.g., a CPU and an application processor (AP), etc.), or graphics-dedicated processors (e.g., a graphics processing unit (GPU) and a vision processing unit (VPU)), and/or AI-dedicated processors (e.g., a neural processing unit (NPU)).

The one or more processors may control processing of input data based on a predefined operation rule or AI model stored in the non-volatile memory and the volatile memory. The predefined operation rules or AI model may be provided through training or learning.

Here, providing the predefined operation rules or AI model(s) through learning refers at least to obtaining a predefined operation rule or AI model with desired characteristics by applying a learning algorithm to a plurality of pieces of training data. The training may be performed by a device having an AI function according to the disclosure, or by a separate server and/or system.

The AI model may include a plurality of neural network layers. Each layer has a plurality of weights, and the calculation of one layer may be performed based on a calculation result of a previous layer and the plurality of weights of the current layer. A neural network may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q network, but is not limited thereto.

The learning algorithm may be a method of training a predetermined target device, for example, a robot, based on a plurality of pieces of training data and of enabling, allowing or controlling the target device to perform determination or prediction. The learning algorithm may include, but is not limited to, for example, supervised learning, unsupervised learning, semi-supervised learning, or reinforcement learning.

The computing apparatuses, the electronic devices, the processors, the memories, the displays, the information output system and hardware, the storage devices, and other apparatuses, devices, units, modules, and components described herein with respect to FIGS. 1-20 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-20 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of processing data, the method comprising:
obtaining target data;
generating a target augmentation task sequence by processing the target data with a trained first model that performs inference on the target data to generate the target data augmentation task sequence;
generated augmented target data by performing data augmentation on the target data according to the target augmentation task sequence; and
obtaining a prediction result corresponding to the target data by inputting the augmented target data to a trained second model and performing a corresponding processing on the augmented target data by the trained second model.

2. The method of claim 1, wherein the target augmentation task sequence comprises at least two augmentation tasks selected by cascaded test time augmentation (TTA) performed by the first model.

3. The method of claim 1, wherein the trained first model comprises:
a first network configured to determine a state feature by performing a first processing of the target data;
a second network configured to determine a target augmentation task corresponding to a current iteration of the trained first model based on a state feature of the current iteration determined by the first network processing the target data; and
a third network configured to determine a state feature of a next iteration based on the state feature of the current iteration and the target augmentation task corresponding to the current iteration.

4. The method of claim 3, wherein the generating of the target augmentation task sequence comprises:
in response to the target augmentation task corresponding to the current iteration being an augmentation task other than an identity task, determining, by the third network, the state feature of the next iteration based on the state feature of the current iteration and the target augmentation task corresponding to the current iteration; and
determining, by the second network, a target augmentation task of the next iteration based on the state feature of the next iteration until an iteration termination condition is satisfied, and in response to the termination condition being satisfied outputting the target augmentation task sequence.

5. The method of claim 4, wherein the iteration termination condition comprises:
a case where a target augmentation task corresponding to any iteration is the identity task; or
a case where a number of iterations reaches a maximum number of iterations.

6. The method of claim 4, wherein the determining of the target augmentation task of the next iteration comprises:
determining, by the second network, an output vector of the next iteration based on the state feature of the next iteration; and
determining, as a target augmentation task of the next iteration, an augmentation task corresponding to a vector satisfying a preset condition in the output vector of the next iteration.

7. The method of claim 4, wherein the generating the target augmentation task sequence comprises:
in response to a number of the target augmentation tasks determined in the current iteration being N, wherein N is greater than 1,
determining the state feature of the next iteration for each target augmentation task and the state feature of the current iteration, determining one target augmentation task of the next iteration based on the state feature of the next iteration, and outputting N target augmentation task sequences by sequentially performing the iteration until the preset iteration termination condition is satisfied;
determining the state feature of the next iteration for each target augmentation task and the state feature of the current iteration, determining N target augmentation tasks of the next iteration based on the state feature of the next iteration, determining, as a target augmentation task of the next iteration, N augmentation tasks from determined N*N augmentation tasks, and outputting N target augmentation task sequences by sequentially performing the iteration until the preset iteration termination condition is satisfied; or
determining the state feature of the next iteration for each target augmentation task and the state feature of the current iteration, and outputting a plurality of target augmentation task sequences by determining N target augmentation tasks of the next iteration until the preset iteration termination condition is satisfied based on the state feature of the next iteration.

8. The method of claim 7, wherein the current iteration comprises a first iteration.

9. The method of claim 1, wherein the obtaining of the prediction result corresponding to the target data by inputting the augmented target data to the trained second model and performing the corresponding processing on the augmented target data comprises:
in response to the target augmentation task sequence comprising a plurality of augmentation tasks, obtaining a plurality of output results by inputting, to the trained second model, each of a plurality of pieces of augmented target data obtained by augmenting data based on the target augmentation task sequence; and
obtaining the prediction result corresponding to the target data by integrating the plurality of output results.

10. The method of claim 3, wherein a process of training a first model that becomes the trained first model comprises:
determining, based on obtained training data, first rank losses of respective predefined augmentation tasks of next iteration training through the first network and the second network, and optimizing the first model based on the first rank losses; and
determining, based on training data of current iteration training, second rank losses of the respective predefined augmentation tasks of the next iteration training through the second network and the third network, and optimizing the first model based on the second rank losses until a number of iterations reaches a preset maximum number of iterations.

11. The method of claim 10, wherein the determining of the second rank losses and optimizing the first model comprises:
determining one augmentation task among the predefined augmentation tasks as a training augmentation task of the next iteration training;
obtaining training data of the next iteration training by performing the training augmentation task of the next iteration training on the training data of the current iteration training; and
determining the second rank losses of the next iteration training through the second network and the third network based on the training data of the next iteration training.

12. The method of claim 10, wherein the determining of the first rank losses and the determining of the second rank losses comprises:
performing each predefined augmentation task on training data of the next iteration training;
obtaining a loss value by inputting, to a second model, training data obtained by the performing the predefined augmentation tasks; and
determining a training label of the next iteration training based on the loss value and determining a rank loss of each augmentation task obtained from the next iteration training based on the corresponding training label.

13. The method of claim 12, wherein the determining of the rank loss of each augmentation task obtained from the next iteration training based on the corresponding training label comprises:
obtaining an output vector output from the second network for the next iteration training; and
determining the rank loss of each augmentation task of the next iteration training by matching the output vector of the next iteration training to the corresponding training label.

14. A non-transitory computer-readable storage medium storing instructions that, when executed by a processor, cause the processor to perform the method of claim 1.

15. A data processing device comprising:
a processor,
wherein the processor is configured to:
obtain target data, generate a target augmentation task sequence by processing the target data with on a trained first model, perform data augmentation on the target data according to the target augmentation task sequence to generate augmented target data, and obtain a prediction result corresponding to the target data by inputting the augmented target data to a trained second model that performs a corresponding processing on the augmented target data.

16. The data processing device of claim 15, wherein the trained first model comprises:
a first network configured to determine a state feature of a first processing of the target data;
a second network configured to determine a target augmentation task corresponding to a current iteration based on a state feature of the current iteration; and
a third network configured to determine a state feature of a next iteration based on the state feature of the current iteration and the target augmentation task corresponding to the current iteration.

17. The data processing device of claim 16, wherein the processor is further configured to:
in a case of generating the target augmentation task sequence by processing the target data based on the trained first model:
in response to the target augmentation task corresponding to the current iteration being an augmentation task other than an identity task, determining the state feature of the next iteration based on the state feature of the current iteration and the target augmentation task corresponding to the current iteration through the third network; and
outputting the target augmentation task sequence by determining a target augmentation task of the next iteration based on the state feature of the next iteration until a preset iteration termination condition is satisfied through the second network.

18. The data processing device of claim 17, wherein the iteration termination condition comprises:
a case where a target augmentation task corresponding to all iterations is the identity task; or
a case where a number of iterations reaches a maximum number of iterations.

19. The data processing device of claim 17, wherein the processor is further configured to:
determine an output vector of the next iteration based on the state feature of the next iteration through the second network; and
determine, as a target augmentation task of the next iteration, an augmentation task corresponding to a vector satisfying a preset condition in the output vector of the next iteration.

20. The data processing device of claim 17, wherein the processor is further configured to:
in a case of obtaining the at least one target augmentation task sequence by processing the target data based on the trained first model:
in response to a number of the target augmentation tasks determined in the current iteration being N, wherein N is greater than 1,
determine the state feature of the next iteration for each target augmentation task and the state feature of the current iteration, determine one target augmentation task of the next iteration based on the state feature of the next iteration, and output N target augmentation task sequences by sequentially performing the iteration until the preset iteration termination condition is satisfied;
determine the state feature of the next iteration for each target augmentation task and the state feature of the current iteration, determine N target augmentation tasks of the next iteration based on the state feature of the next iteration, determine, as a target augmentation task of the next iteration, N augmentation tasks from determined N*N augmentation tasks, and output N target augmentation task sequences by sequentially performing the iteration until the preset iteration termination condition is satisfied; or
determine the state feature of the next iteration for each target augmentation task and the state feature of the current iteration, and output a plurality of target augmentation task sequences by determining N target augmentation tasks of the next iteration until the preset iteration termination condition is satisfied based on the state feature of the next iteration.
